(19) United States
(12) Patent Application Publication
(10) Pub. No.: US 2025/0085785 A1
(43) Pub. Date: Mar. 13, 2025

(54) System and Method for Interacting with a Mobile Device Using Finger Pointing

(71) Applicant: Carnegie Mellon University, Pittsburgh, PA (US)

(72) Inventors: Daehwa Kim, Yeongchen-si (KR); Vimal Mollyn, Pittsburgh, PA (US); Christopher Harrison, Pittsburgh, PA (US)

(73) Assignee: Carnegie Mellon University, Pittsburgh, PA (US)

(21) Appl. No.: 18/829,215

(22) Filed: Sep. 9, 2024

Related U.S. Application Data
(60) Provisional application No. 63/537,163, filed on Sep. 7, 2023.

(51) Int. Cl. G06F 3/01; G06F 3/16

(52) U.S. Cl. CPC G06F 3/017; G06F 3/011; G06F 3/167

(57) ABSTRACT

A system and method allow interaction with a mobile device using finger pointing gestures. The mobile device includes an imaging device having a field of view that contains an object of interest. The system and method are capable of identifying the object of interest in image data captured by the imaging device by casting a ray from a finger of user, who is pointing to the object using traditional pointing gestures. Verbal utterances spoken by the user can be captured and used to provide context about the object of interest.

### CROSS-REFERENCE TO RELATED APPLICATIONS

This application claims the benefit under 35 U.S.C. § 119 of U.S. Provisional Application Ser. No. 63/537,163, filed on Sep. 7, 2023, which is incorporated herein by reference.

### STATEMENT REGARDING FEDERALLY SPONSORED RESEARCH

Not applicable.

### BACKGROUND OF THE INVENTION

The present disclosure generally relates to systems and methods for interacting with a mobile device. More specifically, the disclosure relates to a system and method that allows a user to point to an object in the real world and have that object recognized on the mobile device for interactive purposes.

Pointing with one's finger is a natural and rapid way to denote an area or object of interest. It is routinely used in human-human interaction to increase both the speed and accuracy of communication, but it is rarely utilized in human-computer interactions. In prior works that have utilized human pointing interactions, systems are either room-scale fixed setups (e.g., “Put that There”, in which a graphical interface is overlaid on a large format video display) or virtual/augmented reality experiences. Underexplored, however, is incorporating finger pointing into conventional smartphone interactions.

Alternatively, there are many of examples of device-augmented pointing devices, such as laser pointers and other handheld electronics. Currently popular devices are virtual reality/augmented reality controllers that allow their users to point in 3D virtual space. Similarly, a mobile phone can be moved until cross-hairs on the screen align with an object of interest. However, none of these devices allow a natural, intuitive form of interaction with a mobile device that natural finger pointing allows.

‘2D pointing’, or direct manipulation of interfaces such as a touchscreen, has also been explored. Often, this type of interaction with a mobile device requires use of an application (i.e. app.) and a plurality of steps performed by the user within the app. to identify the object. For example, a user who wishes to attach a paper receipt to an email reimbursement request must first open the email app. The user then clicks the attachment icon, then clicks the camera icon, then takes a photo of the item of interest, then confirms by pressing “Use Photo”, after which the whole photo is inserted into the email. The interaction takes approximately 11 seconds or longer if the user is not particularly adept at using the small icons and interface on the phone's screen. If the user wished to crop-out surrounding content, multiple additional clicks and swipes would be required. Furthermore, the above interaction sequence takes users away from their application context where the content is desired.

The awkward design of the typical mobile device interaction takes the user away from their application context where the content is desired. Therefore, it would be advantageous to develop a system and method for interacting with a mobile device utilizing finger pointing, closely matching the natural way in which humans already communicate with one another, where such interaction does not require navigating away from the current application and losing important context.

### BRIEF SUMMARY

According to embodiments of the present disclosure is a system that utilizes the rear-facing camera of a mobile device, along with hardware-accelerated machine learning, to enable real-time, infrastructure-free, finger-pointing interactions on the mobile device. The method of interaction can be coupled with a voice command to trigger advanced functionality. For example, while composing an email, a user can point at a document on a table and say “attach”. This method requires no navigation away from the current app. and is both faster and more privacy-preserving than the current method of taking a photo. Further, no presses of the device's touchscreen are needed.

In one embodiment running on a smartphone as the mobile device, the system periodically checks for the binary presence of a hand in front of the device. If a hand is detected, a more intensive model that produces a 3D hand pose is run. The system then checks whether the user is forming a valid pointing gesture, and if so, the tracking is increased. Next, the system ray casts the finger vector into the scene. The object upon which the finger vector intersects is “cut-out” of the scene using an image segmentation process. Further interaction can be provided by user voice commands and by presenting the isolated object on the device's screen.

### BRIEF DESCRIPTION OF THE SEVERAL VIEWS OF THE DRAWINGS

FIG. 1 depicts the system according to one embodiment.

FIG. 2 is a block diagram depicting certain steps of the method of interaction using finger pointing.

FIGS. 3A-3D show a user interacting with a mobile device using the system.

### DETAILED DESCRIPTION

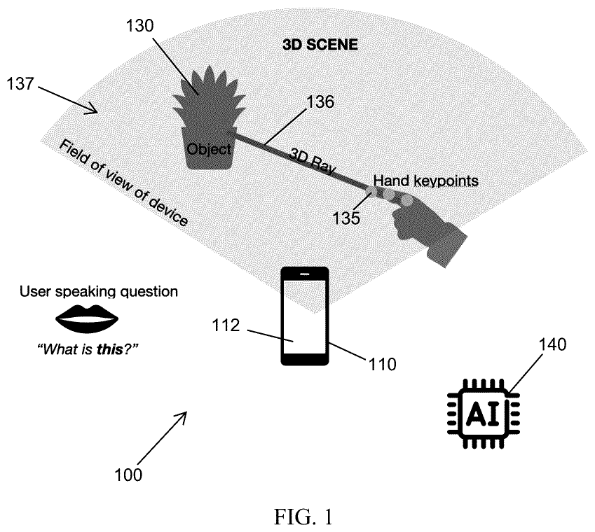

According to embodiments of the disclosure are a system 100 and method for interacting with a mobile device 110 using finger pointing. As shown in FIG. 1, the system 100 comprises a mobile device 110 that includes an imaging device 111 having a field-of-view 137. The mobile device 110 can include a mobile phone, headset, glasses, pin, button, or any other mobile electronic device having an imaging device 111. The imaging device 111 may include one or more of a camera, wide-angle camera, stereo camera, depth camera, lidar (i.e. light detection and ranging) sensor, or similar devices. The field-of-view 137 of the imaging device 111 may largely match the field-of-view of the user, particularly when the user is holding the device 110 with the imaging device 111 facing towards the scene. In this manner, an object 130 of interest visible by the user will be contained within the field-of-view 137 of the imaging device 111 and captured in the image data. Further, the mobile device 110 held in this position will be capable of simultaneously capturing in the image data the user's finger, which can be pointed at the object 130.

Further shown in FIG. 1 is a computer agent or computing module 120, which receives and processes the image data provided by the imaging device 111. The module 120 may comprise a controller, a microcomputer, a microprocessor, a microcontroller, an application specific integrated circuit, a programmable logic array, a logic device, an arithmetic logic unit, a digital signal processor, or another data processor and supporting electronic hardware and software. Further, the module 120 can be implemented on the mobile device 110 or remotely in a cloud environment, for example. The module 120 may also process verbal commands from the user. The computing module 120 processes the image data by identifying and isolating the object 130.

A user begins the process of interaction by pointing to the object 130. It is not necessary for the user to hold the mobile device 110 so that they have a view of the device's screen 112. Rather, if the user's hand is in the field-of-view 137 of the imaging device 111, the computing module 120 will recognize and identify the hand to begin the object detection process. This manner of pointing more closely replicates pointing gestures used in human-to-human interactions. In addition, the user maintains their real-world field-of-view, rather than a digital representation through the device's screen 112.

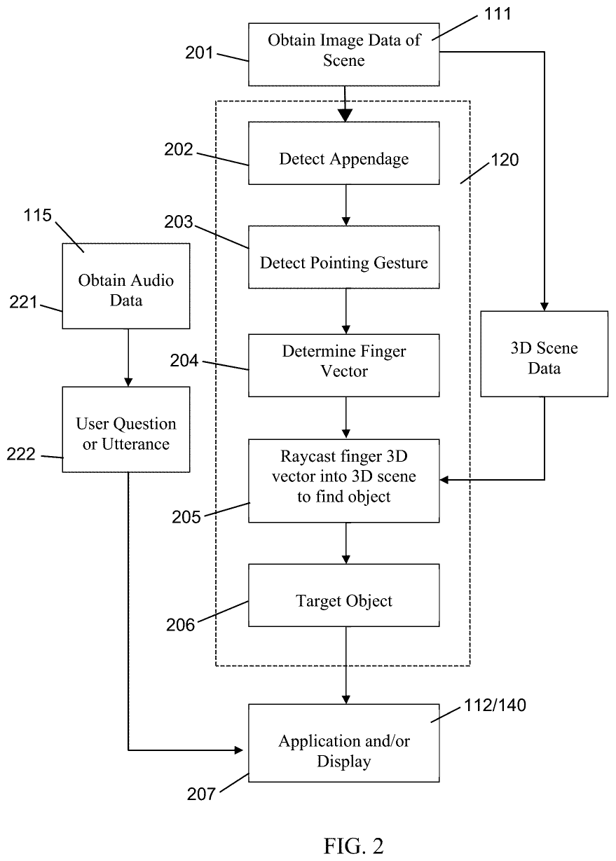

As shown in FIG. 2, the method of interaction comprises a series of steps to locate an object 130 in the scene captured by the imaging device 111 by associating that object 130 with the user's pointing gesture. Specifically, at step 201, the imaging device 111 provides imaging data comprising a view of the scene. The scene is generally the object 130, people, background, scenery, and other items within the field-of-view 137 of the imaging device 111. The imaging data is transmitted to the computing module 120, which uses the image data to perform various steps of the method. First, the computing module 120 detects the user's appendage, such as a finger, hand, arm, or wrist, in the scene at step 202. In one example embodiment, the user's finger is utilized as the pointing appendage, as it more closely follows the typical human pointing action. If a finger is detected, the module 120 determines if the user is pointing a finger (i.e. engaged in a pointing gesture) at step 203.

If the user is pointing a finger, the module determines a 3D vector of the finger at step 204. Next, at step 205, the module 120 casts a ray 136, or 3D vector, extending from the finger into the image data (i.e. 3D scene data) to find the target object 130. Lidar and stereo cameras, when used as the imaging device 111, provide native three-dimensional data in the image data. Alternatively, the 3D scene data can be created from 2D imaging data using techniques known in the art, such as artificial intelligence techniques. At step 206, the target object 130 is stored in the computing module 120.

Simultaneously to the target identification sub-processes, a microphone 115 on the mobile device 110 may capture audio data containing verbal commands from the user at optional step 220. If verbal commands are used, at step 221, the computing module 120 isolates a user question or utterance from the audio data received from the microphone 115. At step 207, the computing module 120 may provide contextual information based on the object 130 and the user question/utterance. Alternatively, the object of interest 130 can be used as an input to an application or AI agent 140. For example, if the user asks “What car is this?”, the object 130 could be sent with the question to an AI agent 140, which can then speak back the particular car model.

By way of further detail, one example embodiment of the system 100 and method is described below. In this example, the device 110 comprises an Apple iPhone® with a rear-facing camera and a LiDAR sensor as the imaging devices 111. This particular mobile device 110 can provide paired RGB and depth images via software contained within the iPhone, such as Apple's ARKit Dev API, at 30 FPS with approximately a 65° field-of-view 137. The ARKit Dev API software integrates hardware sensing on the iPhone to allow augmented reality applications. It should also be noted that while this Apple Iphone® device 110 contains a rear-facing LiDAR sensor 111 to capture depth data, other LiDAR-less smartphones offer similar depth maps derived from deep learning, SLAM, and other methods, such as Android's equivalent software known as ARCore Raw Depth API. These various devices can be used to provide the 3D scene data used in various steps of the method.

The Apple iPhone® device 110 allows use of a wake gesture. Like wake words (e.g., “hey Siri”, “hey Google”), wake gestures should be sufficiently unique so as not to trigger falsely or by accident. Although finger pointing is natural and common, it is uncommon for users to perform this gesture in front of their phones at close range, and thus it can serve as a good wake gesture in the method of interacting. This corresponds to the phone 110 held at a comfortable reading distance, with the arm intentionally extended in front of the body as a trigger. This is most comfortable with the arm kept below the shoulder and with the elbow slightly bent. Note this keeps the arm considerably lower, and thus more comfortable, than systems that employ an eye-finger ray casting (EFRC) pointing method, which also requires a user facing camera to track the user's eyes.

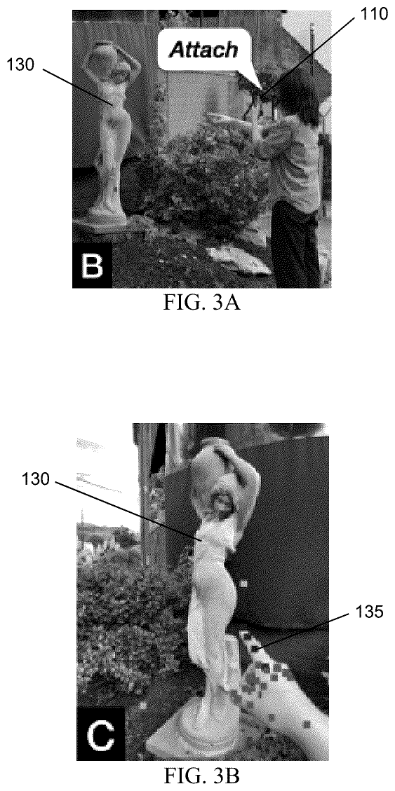

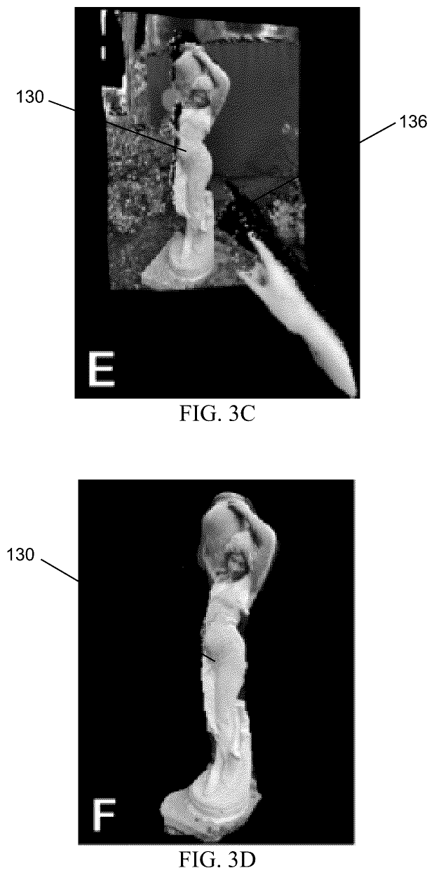

FIGS. 3A-3D depict a user interacting with the system 100. As shown in FIG. 3A, the user points to an object 130 in the real world while holding the mobile device 110. The user is holding the device 110 in a neutral position between the object 130 and their body. It is not necessary to for the user to hold the device 110 directly in their line of sight. The user may also utter a command while pointing at the object 130. The imaging device 111 captures image data including the object 130 and the user's finger. In FIG. 3B, a depth map or 3D scene data is captured directly by the imaging device 111 or derived from the image data. In FIG. 3C a point cloud of the 3D scene data is provided along with a finger ray 136. Finally, in FIG. 3D, the object 130 is segmented from the rest of the objects and background of the scene.

Referring again to FIG. 2, the first step of the method (after image data capture) is to detect whether a hand is present in front of the device 110. For this, the system 100 uses software running on the computing module 120, such as MediaPipe's Palm Detector running as a TensorFlow Lite model, with a confidence setting of 0.5. To conserve power, the system 100 converts 1920×1440 resolution image data to 256×256 frames and runs the model at 1 Hz, sleeping the rest of the time. If a hand candidate is detected in the image data, the system 100 then examines the bounding box to test if the hand is sufficiently large to be the user's hand. This eliminates other distant hands in the scene (i.e., from other people) as well as user hands that are held too close or far from the device 110. If the hand passes these checks, the system 100 moves to the next stage of the processing pipeline.

With a candidate hand detected, the sampling rate increases to 4 Hz. The system 100 runs MediaPipe's Hand Landmark Model (also as a TFLite model) on the candidate bounding box (confidence setting of 0.7; Index finger position @ 20 Hz). If a hand pose is generated, the system 100 then tests to see if it is held in a pointing pose. For this, the computing module 120 uses joint angles to test if the index finger is fully extended and the other fingers are angled and tucked in. If the pose passes this check, the system 100 continues to the next step of the process. At this stage of processing, the system 100 can indicate to the user that their “wake gesture” has been detected and tracked with a small onscreen icon.

With a hand now detected and held in a pointing pose, the sampling rate is increased to 20 Hz to provide a more responsive user experience. To compute a 3D vector for where the finger is pointing, the system 100 uses the index finger's metacarpophalangeal (MCP) and proximal interphalangeal (PIP) keypoints 135, which follows the most common hand-rooted method of index finger ray cast (IFRC). This joint combination is often the most stable during this phase of ray casting, though it must be noted that other joints and even other methods are possible, such as regressing on the index finger's point cloud.

Next, in order to ray cast the pointing vector 136 into the scene and have it correctly intersect with scene geometry, the system 100 requires 3D scene data (i.e., a 2D image is insufficient). In this example embodiment, the system 100 uses Apple's ARKit API, which provides paired RGB and depth images (RGB and Depth) from the imaging sensors 111. From these sources, the system 100 can compute a 3D point cloud in real world units. The system 100 can use Apple's Metal Framework, which permits computational tasks to run on the device's graphical processing unit (GPU), to parallelize this computation. In some embodiments, the GPU is integrated into the computing module 120. Once composited, the system 100 extends a ray 136 from the index finger into the point cloud scene (i.e. 3D scene data). As the point cloud is sparse, the system 100 identifies the point within a specific distance along the ray (Point Cloud), rather than requiring an actual collision.

There are several different ways the finger-pointed location in a scene can be utilized, which will be elaborated. In one implementation, the system 100 uses DeepLabV3 segmentation software trained on 21 classes from Pascal VOC2012, as standard dataset used in image segmentation processes. This model provides masked instance segmentation and runs alongside the rest of the pipeline at 20 FPS on the iPhone device 110. For flat rectangular objects, such as receipts and business cards, the system 100 can take advantage of Apple's built-in Rectangle Detection API software. Alternatively, there are many other techniques for image segmentation, both classical and deep learning based, which can be utilized during this step.

To avoid the Midas Touch problem, where an object is unintentionally selected, finger pointing is best combined with an independent input modality that acts as a trigger or clutch. For this, spoken commands can be a natural compliment. To implement this functionality, the system 100 uses Apple Speech Framework software to register keywords and phrases, which then trigger event handlers for specific functionality. For example, a spoken keyword can be used as a verbal trigger to initiate the capturing of image data of a scene.

The functionality provided by the method can be utilized as a background process, as opposed to taking over the screen with a new interface. Several examples of use will be described.

In the first example, the method can be used to quickly and conveniently attach to an email images of objects 130 in the real world, such as a document or meal. While composing an email, users simply raise their hand to point to an object. In addition to an icon, a preview of the attachment appears on the screen of the device 110. If the user wishes to attach an image of this object to their email, they simply say aloud “attach”, without the need for any wake word. This interaction can be repeated in rapid succession for many attachments, or the user can end the interaction by releasing the pointing pose or dropping their hand. Such an attach-from-world interaction need not be limited to an email client and is broadly applicable to any application capable of handling media, including messaging, social media, and note-taking apps.

In another example use, real world objects can be digitally copied. Whereas the “attach” interaction directs media into the foreground application, the method can be used for an application-agnostic, system-wide, copy-from-world-to-clipboard interaction. More specifically, at any time, even when not in an application capable of receiving media, the user can point to an object and say “copy”. This copies an image of the pointed object to the system clipboard for later use.

In yet another example use, the system 100 and method can be used to support more semantically-specific interactions, such as pointing to a business card and saying “add to contacts” or pointing to a grocery item and saying “add to shopping list”. As before, the latter interactions could happen while the user is in any application (without any need to navigate away from the current task), and the captured information would be passed to the application associated with the spoken command.

In another example, the system 100 and method can be used for search and information retrieval tasks for objects in the world. For instance, a user could be walking down the street scrolling through their social media feed, and while passing a restaurant, point to it and say “What's good to eat here?”, “what's the rating for this place?” or “what time does this close?” In a similar fashion, a user could point to a car parked on the street and ask “What model is this?” or “How much does this cost?” Or, more generally, the user could point to an electric scooter and say “Show me more info”.

The system 100 and method can also be used to control other objects. For example, in human-human interactions, finger pointing can be used to address and issue commands to other humans (e.g., “you go there”). This type of interaction could likewise work for smart objects (e.g., “on” while pointing at a TV or light switch). Sharing of media is also possible, such as looking at a photo or listening to music on a smartphone, and then pointing to a TV and saying “share”, “play here” or similar. It may even be possible to use technologies such as UWB to achieve AirDrop-like file transfer functionality by pointing to a nearby device. Users could also ask questions about the physical properties of objects, such as “How big is this?” or “How far is this?”. A drawing app could even eye-dropper colors from the real world using a finger pointing interaction (e.g., “this color”).

When used in this specification and claims, the terms “comprises” and “comprising” and variations thereof mean that the specified features, steps, or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure. Although certain example embodiments of the invention have been described, the scope of the appended claims is not intended to be limited solely to these embodiments. The claims are to be construed literally, purposively, and/or to encompass equivalents.

What is claimed is:

1. A system for interacting with a mobile device comprising:
a mobile device having an imaging device adapted to obtain image data of a scene in the vicinity of a user,
wherein the imaging device is positioned to simultaneously capture image data related to an object in the scene and a user's appendage positioned within a field-of-view of the imaging device;
a computing module that receives the image data from the imaging device, wherein the computing module is adapted to:
associate a pointing gesture of the appendage with the object, and
isolate the object from a remainder of the scene;
a screen for displaying the object.

2. The system of claim 1, wherein the imaging device comprises a device capable of obtaining three-dimensional data.

3. The system of claim 1, wherein the imaging device comprises at least one of a camera, wide-angle camera, stereo camera, depth camera, and lidar device.

4. The system of claim 1, wherein the computing module is contained within the mobile device.

5. The system of claim 1, wherein the computing module is remotely connected to the mobile device.

6. The system of claim 1, wherein the appendage is a finger.

7. The system of claim 1, wherein the mobile device comprises a mobile phone, headset, electronic glasses, pin, button, or a similar mobile electronic device.

8. The system of claim 1, further comprising:
a microphone adapted to receive audio data.

9. The system of claim 8, wherein the audio data comprises a verbal keyword, wherein the keyword triggers a function in the computing module.

10. A method of identifying an object contained within a field of view of an imaging device comprising:
capturing image data of a scene contained within the field of view of the imaging device;
transmitting the image data to a computing module;
using the computing module, identifying an appendage of the user in the scene and, if an appendage is present, further determining whether a portion of the appendage is in a pointing gesture;
using the computing module, casting a three-dimensional vector extending from the appendage into the scene; and
using the computing module, associating the line with an object in the scene.

11. The method of claim 10, further comprising:
capturing audio data using a microphone; and
using the computing module, isolating an utterance from the audio data; and
using the computing module, providing context about the object based on the utterance.

12. The method of claim 10, further comprising:
comparing a size of the appendage to determine if the appendage is the user's appendage or another appendage contained in the scene.

13. The method of claim 10, wherein determining whether a portion of the appendage is in a pointing gesture comprises:
identifying joint angles of an index finger on the appendage; and
identifying whether fingers other than the index finger are tucked towards the appendage.

14. The method of claim 13, further comprising:
identifying keypoints on the index finger.

15. The method of claim 10, wherein capturing image data of a scene contained within the field of view of the imaging device begins only after initiation by a verbal trigger.

16. The method of claim 10, further comprising:
identifying a wake gesture in the image data.

17. The method of claim 16, wherein the wake gesture comprises a finger pointing pose.

18. The method of claim 10, further comprising:
using the object as an input to an application or an AI agent.
